(19) United States
(12) Patent Application Publication
(10) Pub. No.: US 2019/0265525 A1
(43) Pub. Date: Aug. 29, 2019

(54) LIQUID CRYSTAL PANEL AND FABRICATING METHOD THEREOF

(71) Applicant: SHENZHEN CHINA STAR OPTOELECTRONICS TECHNOLOGY CO., LTD., Shenzhen (CA)

(72) Inventors: Xingwu CHEN, Shenzhen (CN); Xiaolong MA, Shenzhen (CN)

(21) Appl. No.: 16/407,903

(22) Filed: May 9, 2019

Related U.S. Application Data
(62) Division of application No. 15/113,734, filed on Jul. 22, 2016.

(30) Foreign Application Priority Data
Feb. 18, 2016 (CN) 201610090348.3

(51) Int. Cl. G02F 1/1337; G02F 1/137

(52) U.S. Cl. CPC G02F 1/1337; G02F 1/133788; G02F 2001/13775; G02F 2001/133773; G02F 2202/36; G02F 1/137

(57) ABSTRACT

A liquid crystal panel and a method of fabricating the same are described. For the liquid crystal panel, an optical alignment treatment is performed to irradiate a polarized ultraviolet light to an optical alignment layer in advance. Thus, when a polymerizing step is performed, tilting directions of the liquid crystal molecules can be made uniform, thereby solving the problem of reducing an optical transmittance existing in the conventional technology.

### CROSS REFERENCE TO RELATED APPLICATIONS

This application is a divisional application of U.S. patent application Ser. No. 15/113,734, filed on Jul. 22, 2016, which claims the priority of International Application No. PCT/CN2016/078025, filed on Mar. 31, 2016, which claims priority to Chinese Application No. 201610090348.3, filed on Feb. 18, 2016. The entire disclosures of the above applications are incorporated herein by reference.

### FIELD OF THE INVENTION

The present invention relates to a display structure and a fabricating method thereof, and more particularly to a liquid crystal panel and a fabricating method thereof.

### BACKGROUND OF THE INVENTION

A Nano-Phase-Separated Liquid Crystals (NPS LCs) technology is a liquid crystal composition comprising a plurality of liquid crystal molecules and a plurality of polymerizable monomers, wherein the polymerizable monomers are irradiated by an ultraviolet light so as to form a plurality of polymer networks. These polymer networks can promote a responding speed of the liquid crystal molecules to achieve within one millisecond.

However, the Nano-Phase-Separated Liquid Crystals technology has a shortcoming with a relatively low optical transmittance. This is because the Nano-Phase-Separated Liquid Crystals technology usually uses a technology of full transparent conductive film (Full ITO), which means that a complete transparent conductive film is formed on each of a top substrate and a bottom substrate. This kind of transparent conductive film cannot cause the liquid crystal molecules to produce a pre-tilt angle by using conventional technologies (such as fabricating a plurality of bumps or etching a plurality of slits, etc.). Therefore, when a voltage is inputted to perform a step of irradiating the polymerizable monomers by the ultraviolet light, if tilt directions of the neighboring liquid crystal molecules are inconsistent, the optical transmittance will be reduced.

As a result, it is necessary to provide a liquid crystal panel and a fabricating method thereof to solve the problems existing in the conventional technologies.

### SUMMARY OF THE INVENTION

In view of this, the present invention provides a liquid crystal panel and a fabricating method thereof, so as to solve the problem of reduced optical transmittance existing in the conventional technology.

A primary object of the present invention is to provide a liquid crystal panel and a fabricating method thereof, in which an optical alignment can be performed to a first optical alignment layer and a second optical alignment layer, such that tilt directions of a plurality of liquid crystal molecules can be made uniform when a polymerizing step is performed, thereby solving the problem of reducing optical transmittance existing in the conventional technology.

To achieve the above object of the present invention, an embodiment of the present invention provides a liquid crystal panel, comprising a first substrate, a second transparent conductive film, a first optical alignment layer, a liquid crystal composition layer, a second optical alignment layer, a second transparent conductive layer, and a second substrate. The first transparent conductive film is disposed on the first substrate. The first optical alignment layer is disposed on the first transparent conductive film The liquid crystal composition layer is disposed on the first optical alignment layer and comprises: a plurality of liquid crystal molecules; and a plurality of polymer networks formed by polymerizing a plurality of reactive monomers, wherein the liquid crystal molecules and the polymer networks are two separated phases. The second optical alignment layer is disposed on the liquid crystal composition layer. The second transparent conductive layer disposed on the second optical alignment layer. The second substrate is disposed on the second transparent conductive layer, wherein the first substrate is a thin film transistor array substrate; and wherein the second substrate is a color filter substrate.

In one embodiment of the present invention, the liquid crystal molecules are a plurality of negative type liquid crystal molecules, and each of the first optical alignment layer and the second optical alignment layer is vertical optical alignment material irradiated by a polarized ultraviolet light.

In one embodiment of the present invention, the liquid crystal molecules are a plurality of positive type liquid crystal molecules, and each of the first optical alignment layer and the second optical alignment layer is parallel optical alignment material irradiated by a polarized ultraviolet light.

To achieve the above object of the present invention, another embodiment of the present invention provides a liquid crystal panel, comprising a first substrate, a second transparent conductive film, a first optical alignment layer, a liquid crystal composition layer, a second optical alignment layer, a second transparent conductive layer, and a second substrate. The first transparent conductive film is disposed on the first substrate. The first optical alignment layer is disposed on the first transparent conductive film. The liquid crystal composition layer is disposed on the first optical alignment layer and comprises: a plurality of liquid crystal molecules; and a plurality of polymer networks formed by polymerizing a plurality of reactive monomers, wherein the liquid crystal molecules and the polymer networks are two separated phases. The second optical alignment layer is disposed on the liquid crystal composition layer. The second transparent conductive layer disposed on the second optical alignment layer. The second substrate is disposed on the second transparent conductive layer.

In one embodiment of the present invention, the first substrate is a thin film transistor array substrate.

In one embodiment of the present invention, the second substrate is a color filter substrate.

In one embodiment of the present invention, the liquid crystal molecules are a plurality of negative type liquid crystal molecules, and each of the first optical alignment layer and the second optical alignment layer is vertical optical alignment material irradiated by a polarized ultraviolet light

In one embodiment of the present invention, the liquid crystal molecules are a plurality of positive type liquid crystal molecules, and each of the first optical alignment layer and the second optical alignment layer is parallel optical alignment material irradiated by a polarized ultraviolet light.

Furthermore, another embodiment of the present invention provides a method of fabricating a liquid crystal panel, comprising steps of: providing a first substrate and a second substrate; forming a first transparent conductive film on the first substrate, and forming a second transparent conductive film on the second substrate; forming a first optical alignment layer on the first transparent conductive film, and forming a second optical alignment layer on the second transparent conductive film; performing an optical alignment step by providing a first polarized ultraviolet light to the first optical alignment layer, wherein a first pre-tilt angle of the first polarized ultraviolet light with respect to a vertical direction of the first optical alignment layer is between 0 and 90 degrees; and by providing a second polarized ultraviolet light to the second optical alignment layer, wherein a second pre-tilt angle of the second polarized ultraviolet light with respect to a vertical direction of the second optical alignment layer is between 0 and 90 degrees; providing a mixture layer sandwiched between the first optical alignment layer and the second optical alignment layer, wherein the mixture layer comprises a plurality of liquid crystal molecules and a plurality of reactive monomers; and performing a polymerizing step by providing an ultraviolet light to the mixture layer so as to form a liquid crystal composition layer, wherein the liquid crystal composition layer comprises: the liquid crystal molecules; and a plurality of polymer networks formed by polymerizing the reactive monomers, wherein the liquid crystal molecules and the polymer networks are two separated phases.

In one embodiment of the present invention, in performing the polymerizing step, a main reactive wavelength of the ultraviolet light is 313 nm or 365 nm, and a reactive temperature of the polymerizing step is ranged from 30° C. to 60° C.

In one embodiment of the present invention, in performing the optical alignment step, the method further comprises steps of: providing a first optical mask between the first polarized ultraviolet light and the first optical alignment layer; and providing a second optical mask between the second polarized ultraviolet light and the second optical alignment layer.

In one embodiment of the present invention, a slit width of the first optical mask is greater than 0 μm and less than or equal to 50 μm; and a slit width of the second optical mask is greater than 0 μm and less than or equal to 50 μm.

In one embodiment of the present invention, a main reactive wavelength of the first polarized ultraviolet light is ranged from 250 nm to 370 nm; and a main reactive wavelength of the second polarized ultraviolet light is ranged from 250 nm to 370 nm.

In one embodiment of the present invention, the liquid crystal molecules are a plurality of negative type liquid crystal molecules, and each of the first optical alignment layer and the second optical alignment layer is vertical optical alignment material.

In one embodiment of the present invention, the liquid crystal molecules are a plurality of positive type liquid crystal molecules, and each of the first optical alignment layer and the second optical alignment layer is parallel optical alignment material.

In comparison with the conventional technologies, the liquid crystal panel and the fabricating method thereof of the present invention is that an optical alignment is performed to a first optical alignment layer and a second optical alignment layer, such that tilt directions of a plurality of liquid crystal molecules can be made uniform when a polymerizing step is performed, thereby solving the problem of reducing optical transmittance existing in the conventional technology.

To make the above description of the present invention more clearly comprehensible, it is described in detail below in examples of preferred embodiments with the accompanying drawings.

### DESCRIPTION OF THE DRAWINGS

FIG. 1 is a cross-sectional schematic diagram of a liquid crystal panel of an embodiment of the present invention.

FIGS. 2A to 2D are cross-sectional schematic diagrams of each of the fabricating processes of a liquid crystal panel of an embodiment of the present invention.

FIG. 3 is a flow chart of a fabricating method of a liquid crystal panel of an embodiment of the present invention.

### DETAILED DESCRIPTION OF THE PREFERRED EMBODIMENTS

The following description of the embodiments with reference to the appended drawings is used for illustrating specific embodiments which may be used for carrying out the present invention. Furthermore, the directional terms described by the present invention, such as upper, lower, top, bottom, front, back, left, right, inner, outer, side, around, center, horizontal, lateral, vertical, longitudinal, axial, radial, uppermost or lowermost, etc., are only directions by referring to the accompanying drawings. Thus, the used directional terms are used to describe and understand the present invention, but the present invention is not limited thereto.

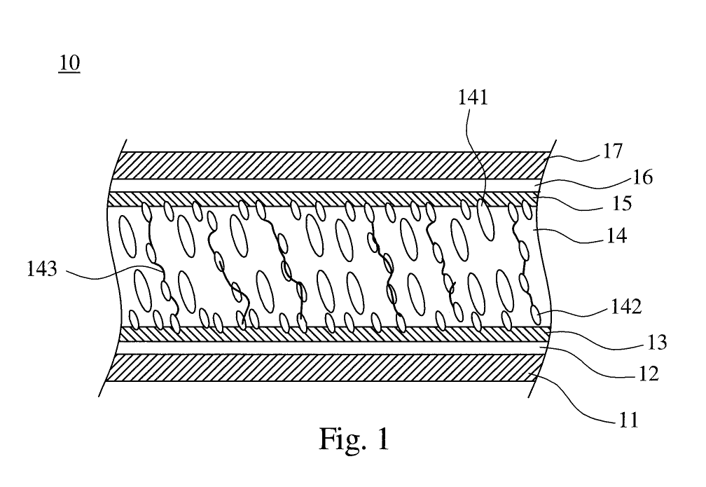

Please refer to FIG. 1. FIG. 1 is a cross-sectional schematic diagram of a liquid crystal panel 10 of an embodiment of the present invention. The liquid crystal panel 10 comprises a first substrate 11, a second transparent conductive film 12, a first optical alignment layer 13, a liquid crystal composition layer 14, a second optical alignment layer 15, a second transparent conductive layer 16, and a second substrate 17. In one embodiment, the first substrate 11 is a thin film transistor array substrate.

In the liquid crystal panel 10, the first transparent conductive film 12 is disposed on the first substrate 11. In one embodiment, the first transparent conductive film 12 is deposited on the first substrate 11 in an entire surface type. In a further embodiment, the first transparent conductive film 12 is formed from indium tin oxide (ITO).

In the liquid crystal panel 10, the first optical alignment layer 13 is disposed on the first transparent conductive film. In one embodiment, the first optical alignment layer 13 is deposited on the first transparent conductive film 12. In another embodiment, the first optical alignment layer 13 can be vertical optical alignment material or parallel optical alignment material irradiated (inclinedly) by a polarized ultraviolet light.

In the liquid crystal panel 10, the liquid crystal composition layer 14 is disposed on the first optical alignment layer. The liquid crystal composition layer 14 comprises a plurality of liquid crystal molecules 141 and a plurality of polymer networks 143 formed by polymerizing a plurality of reactive monomers 142, wherein the liquid crystal molecules and the polymer networks are two separated phases. In one embodiment, the liquid crystal molecules 141 can be a plurality of positive type liquid crystal molecules or a plurality of negative type liquid crystal molecules.

In the liquid crystal panel 10, the second optical alignment layer 15 is disposed on the liquid crystal composition layer 14. In one embodiment, the second optical alignment layer 15 can be vertical optical alignment material or parallel optical alignment material irradiated (inclinedly) by a polarized ultraviolet light. In a specific embodiment, materials of the liquid crystal molecules 141, the first optical alignment layer 13 and the second optical alignment layer 15 have pairing relations. For example, if the liquid crystal molecules 141 are the negative type liquid crystal molecules, then each of the first optical alignment layer 13 and the second optical alignment layer 15 is vertical optical alignment material irradiated (inclinedly) by a polarized ultraviolet light; and if the liquid crystal molecules 141 are the positive type liquid crystal molecules, then each of the first optical alignment layer 13 and the second optical alignment layer 15 is parallel optical alignment material irradiated (inclinedly) by a polarized ultraviolet light.

In the liquid crystal panel 10, the second transparent conductive layer 16 is disposed on the second optical alignment layer 15. In one embodiment, the second transparent conductive film 16 is formed from indium tin oxide.

In the liquid crystal panel 10, the second substrate 17 is disposed on the second transparent conductive layer 16. In one embodiment, the second substrate 17 is a color filter substrate.

In one embodiment, the liquid crystal panel 10 is fabricated by a Nano-Phase-Separated Liquid Crystals technology, so as to have a good liquid crystal responding speed, and color images can be outputted by a field sequential display mode. Therefore, a color filter is not required to be fabricated additionally.

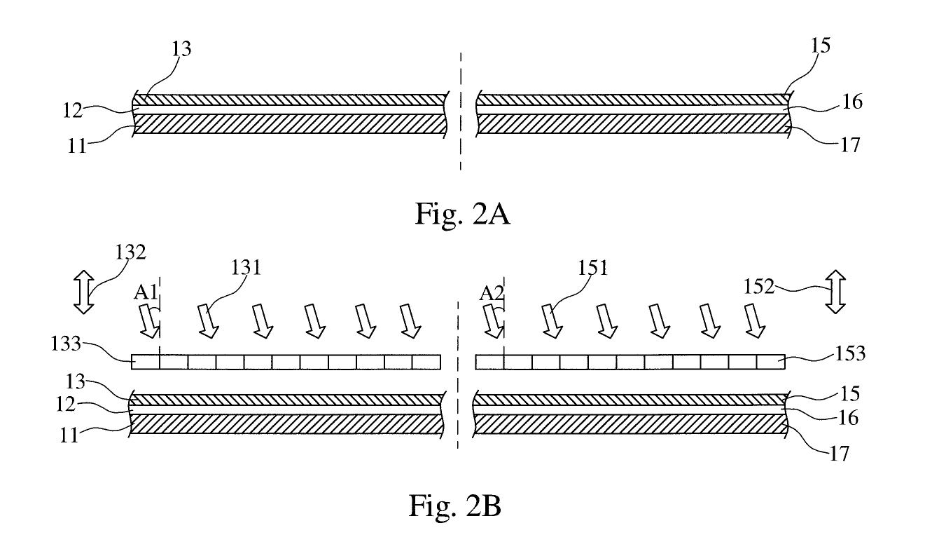

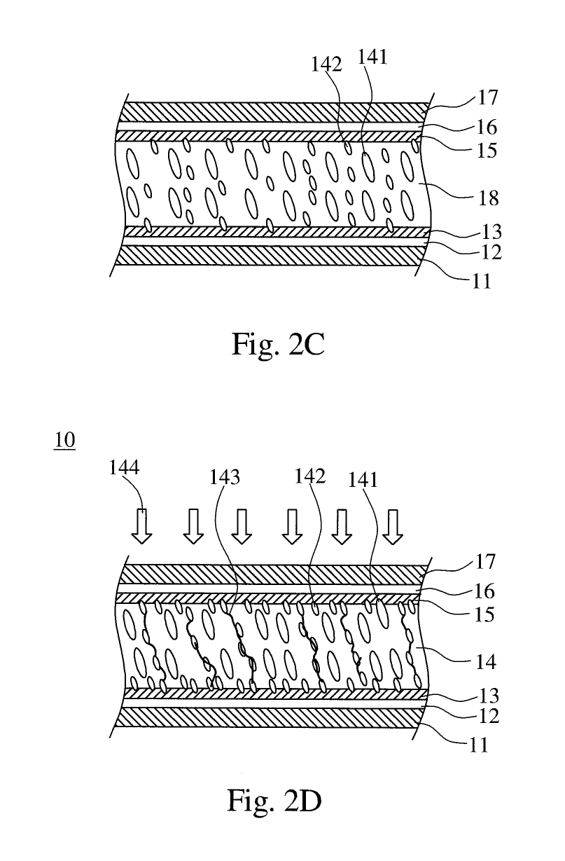

Please refer to FIGS. 2A to 2D. FIGS. 2A to 2D are cross-sectional schematic diagrams of each of the fabricating processes of a liquid crystal panel 10 of an embodiment of the present invention. Please refer to FIG. 2A first. A first substrate 11 and a second substrate 17 are provided. Then, a first transparent conductive film 12 is formed on the first substrate 11, and a second transparent conductive film 16 is formed on the second substrate 17. In one embodiment, each of the first transparent conductive film 12 and second transparent conductive film 16 is formed from indium tin oxide. In another embodiment, the first transparent conductive film 12 is deposited on the first substrate 11, and the second transparent conductive film 16 is deposited on the second substrate 17. Next, a first optical alignment layer 13 is formed on the first transparent conductive film 12, and a second optical alignment layer 15 is formed on the second transparent conductive film 16. In one embodiment, the first optical alignment layer 13 is deposited on the first transparent conductive film 12, and the second optical alignment layer 15 is deposited on the second transparent conductive film 16.

Please refer to FIG. 2B. an optical alignment step is performed by providing a first polarized ultraviolet light 131 to the first optical alignment layer 13, wherein a first pre-tilt angle A1 of the first polarized ultraviolet light 131 with respect to a vertical direction 132 of the first optical alignment layer 13 is between 0 and 90 degrees; and by providing a second polarized ultraviolet light 151 to the second optical alignment layer 15, wherein a second pre-tilt angle A2 of the second polarized ultraviolet light 151 with respect to a vertical direction 152 of the second optical alignment layer 15 is between 0 and 90 degrees. The first pre-tilt angle A1 and second pre-tilt angle A2 are respectively, for example, 0.5 degrees, 1 degrees, 3 degrees, 5 degrees, 8 degrees, 10 degrees, 12 degrees, 15 degrees, 20 degrees, 25 degrees, 30 degrees, 45 degrees, 60 degrees, 75 degrees, 80 degrees, 85 degrees, 89 degrees, 89.5 degrees, and so on. In one embodiment, in performing the optical alignment step, the method further comprises steps of: providing a first optical mask 133 between the first polarized ultraviolet light 131 and the first optical alignment layer 13; and providing a second optical mask 153 between the second polarized ultraviolet light 151 and the second optical alignment layer 15. The first optical mask 133 and the second optical mask 153 are mainly designed to divide pixels (not shown) of the liquid crystal panel 10 into a plurality of domains (not shown). In one embodiment, a slit width of the first optical mask is greater than 0 μm and smaller than or identical to 50 μm; and a slit width of the second optical mask is greater than 0 μm and smaller than or identical to 50 μm. In another embodiment, a main reactive wavelength of the first polarized ultraviolet light 131 is ranged from 250 nm to 370 nm; and a main reactive wavelength of the second polarized ultraviolet light 151 is ranged from 250 nm to 370 nm.

Please refer to FIG. 2C. A mixture layer 18 is provided and sandwiched between the first optical alignment layer 13 and the second optical alignment layer 15, wherein the mixture layer 18 comprises a plurality of liquid crystal molecules 141 and a plurality of reactive monomers 142. In one embodiment, materials of the liquid crystal molecules 141, the first optical alignment layer 13 and the second optical alignment layer 15 have pairing relations. For example, if the liquid crystal molecules 141 are the negative type liquid crystal molecules, then each of the first optical alignment layer 13 and the second optical alignment layer 15 is vertical optical alignment material; and if the liquid crystal molecules 141 are the positive type liquid crystal molecules, then each of the first optical alignment layer 13 and the second optical alignment layer 15 is parallel optical alignment material.

Please refer to FIG. 2D. A polymerizing step is performed by providing an ultraviolet light 144 to the mixture layer 18 so as to form a liquid crystal composition layer 14, wherein the liquid crystal composition layer 14 comprises the liquid crystal molecules 141; and a plurality of polymer networks 143 formed by polymerizing the reactive monomers 142, wherein the liquid crystal molecules 141 and the polymer networks 143 are two separated phases. In one embodiment, a main reactive wavelength of the ultraviolet light is 313 nm or 365 nm, and a reactive temperature of the polymerizing step is ranged from 30° C. to 60° C.

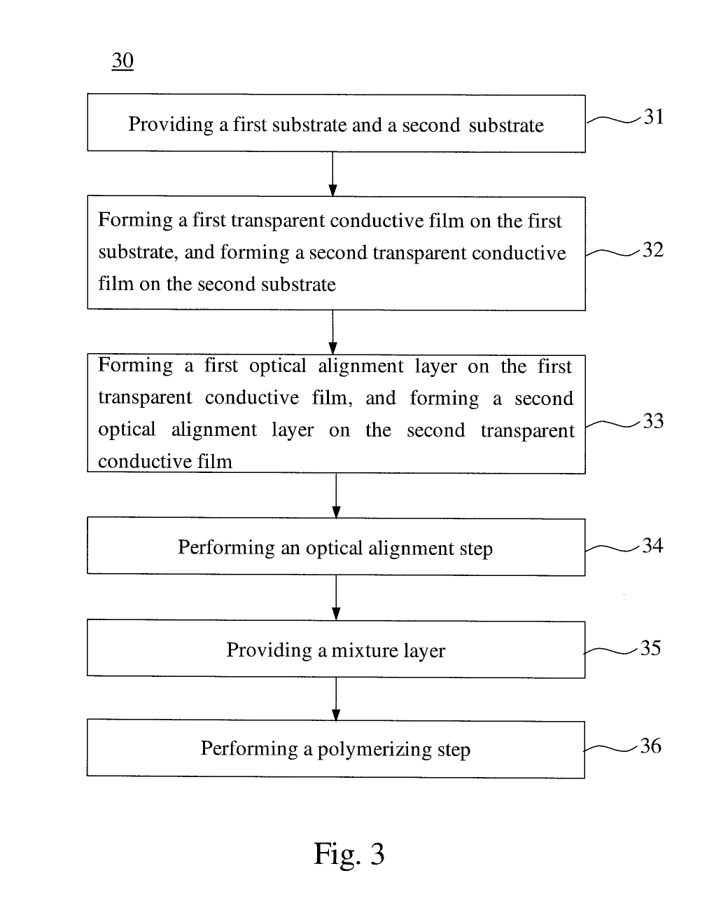

FIG. 3 is a flow chart of a fabricating method 30 of a liquid crystal panel of an embodiment of the present invention. The present invention provides a method 30 of fabricating a liquid crystal panel, comprising steps of: providing a first substrate and a second substrate (step 31); forming a first transparent conductive film on the first substrate, and forming a second transparent conductive film on the second substrate (step 32); forming a first optical alignment layer on the first transparent conductive film, and forming a second optical alignment layer on the second transparent conductive film (step 33); performing an optical alignment step by providing a first polarized ultraviolet light to the first optical alignment layer, wherein a first pre-tilt angle of the first polarized ultraviolet light with respect to a vertical direction of the first optical alignment layer is between 0 and 90 degrees; and by providing a second polarized ultraviolet light to the second optical alignment layer, wherein a second pre-tilt angle of the second polarized ultraviolet light with respect to a vertical direction of the second optical alignment layer is between 0 and 90 degrees (step 34); providing a mixture layer sandwiched between the first optical alignment layer and the second optical alignment layer, wherein the mixture layer comprises a plurality of liquid crystal molecules and a plurality of reactive monomers (step 35); and performing a polymerizing step by providing an ultraviolet light to the mixture layer so as to form a liquid crystal composition layer, wherein the liquid crystal composition layer comprises: the liquid crystal molecules; and a plurality of polymer networks formed by polymerizing the reactive monomers, wherein the liquid crystal molecules and the polymer networks are two separated phases (step 36).

It is noted that, a liquid crystal panel and a fabricating method thereof of the present invention are to perform an optical alignment to a first optical alignment layer and a second optical alignment layer. Because the optical alignment is performed in advance to a vertical or parallel optical alignment material of the first optical alignment layer and second optical alignment layer such that the material molecules thereof have a pre-tilt angle (0˜90 degrees), therefore when a polymerizing step is performed, the liquid crystal molecules are promoted to have a tendency of the same tilt, and the consistency of the tilt direction of the liquid crystal molecules are improved after polymerizing, thereby solving the problem of reduced optical transmittance existing in the conventional technology.

The present invention has been described in relative embodiments described above. However, the above embodiments are merely examples of performing the present invention. It must be noted that the implementation of the disclosed embodiments does not limit the scope of the invention. On the contrary, modifications and equal settings included in the spirit and scope of the claims are all included in the scope of the present invention.

What is claimed is:

1. A method of fabricating a liquid crystal panel, comprising steps of:
providing a first substrate and a second substrate;
forming a first transparent conductive film on the first substrate, and forming a second transparent conductive film on the second substrate;
forming a first optical alignment layer on the first transparent conductive film, and forming a second optical alignment layer on the second transparent conductive film;
performing an optical alignment step by providing a first polarized ultraviolet light to the first optical alignment layer, wherein a first pre-tilt angle of the first polarized ultraviolet light with respect to a vertical direction of the first optical alignment layer is between 0 and 90 degrees; and by providing a second polarized ultraviolet light to the second optical alignment layer, wherein a second pre-tilt angle of the second polarized ultraviolet light with respect to a vertical direction of the second optical alignment layer is between 0 and 90 degrees;
providing a mixture layer sandwiched between the first optical alignment layer and the second optical alignment layer, wherein the mixture layer comprises a plurality of liquid crystal molecules and a plurality of reactive monomers; and
performing a polymerizing step by providing an ultraviolet light to the mixture layer so as to form a liquid crystal composition layer, wherein the liquid crystal composition layer comprises:
the liquid crystal molecules; and
a plurality of polymer networks formed by polymerizing the reactive monomers,
wherein the liquid crystal molecules and the polymer networks are two separated phases.

2. The method of fabricating a liquid crystal panel according to claim 1, wherein in performing the polymerizing step, a main reactive wavelength of the ultraviolet light is 313 nm or 365 nm, and a reactive temperature of the polymerizing step is ranged from 30° C. to 60° C.

3. The method of fabricating a liquid crystal panel according to claim 1, wherein in performing the optical alignment step, the method further comprises steps of: providing a first optical mask between the first polarized ultraviolet light and the first optical alignment layer; and providing a second optical mask between the second polarized ultraviolet light and the second optical alignment layer.

4. The method of fabricating a liquid crystal panel according to claim 3, wherein a slit width of the first optical mask is greater than 0 μm and smaller than or identical to 50 μm; and a slit width of the second optical mask is greater than 0 μm and smaller than or identical to 50 μm.

5. The method of fabricating a liquid crystal panel according to claim 3, wherein a main reactive wavelength of the first polarized ultraviolet light is ranged from 250 nm to 370 nm; and a main reactive wavelength of the second polarized ultraviolet light is ranged from 250 nm to 370 nm.

6. The method of fabricating a liquid crystal panel according to claim 1, wherein the liquid crystal molecules are a plurality of negative type liquid crystal molecules, and each of the first optical alignment layer and the second optical alignment layer is vertical optical alignment material.

7. The method of fabricating a liquid crystal panel according to claim 1, wherein the liquid crystal molecules are a plurality of positive type liquid crystal molecules, and each of the first optical alignment layer and the second optical alignment layer is parallel optical alignment material.
